(19) United States
(12) Patent Application Publication
(10) Pub. No.: US 2002/0065693 A1
(43) Pub. Date: May 30, 2002

(54) Scheme for promoting purchases by reminding purchases through network according to user's location and state

(75) Inventors: Masanori Hattori, Tokyo (JP); Naoki Kase, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Minato-ku (JP)

(21) Appl. No.: 09/904,497

(22) Filed: Jul. 16, 2001

(30) Foreign Application Priority Data
Jul. 17, 2000 (JP) 2000-216691

(51) Int. Cl. G06F 17/60

(52) U.S. Cl. 705/7; 705/28

(57) ABSTRACT

In a purchase promotion server system, electronic goods/services information indicating goods/services scheduled to be purchased or goods/services desired to be purchased is stored for each user, a user state of a user regarding whether the user is fit to purchasing of goods/services is judged according to state data including a location information of the user, and a message urging/reminding the user to purchase the goods/services scheduled to be purchased or the goods/services desired to be purchased indicated by the electronic goods/services information is sent to the user via a network according to the user state of the user.

### BACKGROUND OF THE INVENTION

1. Field of the Invention

The present invention relates to a technique for promoting activities to purchase goods or services, and more particularly, to a scheme for promoting purchases by utilizing characteristics of a computer network such as its ability to cover a wide area and support bidirectional communications.

2. Description of the Related Art

In recent years, in conjunction with the advance of the information processing technology centered around the computer network, there has been propositions of techniques for realizing information distribution with respect to many users for the sake of promoting activities to purchase goods or services. One such technique is a location information service, such as the “location information contents service” provided by the DDI pocket, Inc. of Japan (http://www.ddipocket/joho/joho/i_li.html).

In the location information contents service, when a terminal location information sending function is activated on a PHS (Personal Handy-phone System) terminal, the terminal automatically notifies a base station information recognized at the terminal, i.e., base station IDs and their respective electric field strengths of a plurality of base stations with which radio signals can be exchanged at a current location, to a center at a time of accessing the contents service from the terminal, and upon receiving this notification, the center notifies the user's location, such as a latitude and a longitude, for example, to a contents provider (information provider). The contents provider can provide information on shops in a vicinity of the current location of the user according to the notified location information, for example, such that it becomes possible to provide information that is useful according to the location of the individual user or information with added values.

Also, as a technique for carrying out the information processing for the sake of the user on the computer network, there is a technique called “agent”. This agent is a software entity that autonomously behaves according to circumstances. In particular, there has been a proposition of an agent system in which a processing procedure called “plan” for controlling the agent is generated dynamically so as to deal with changes in constituent elements of the softwares on the network flexibly and improve the fault tolerance with respect to channel faults (U.S. Pat. No. 6,134,580.

The agent disclosed in U.S. Pat. No. 6,134,580 has means for generating and executing the plan, dynamically generates the plan for achieving the goal entered into the agent by the user, and carries out the processing while moving through the agent execution environments on the other computers through a network according to the need.

However, in the conventional techniques as described above, it has been difficult to promote purchases effectively because of the following difficulties. First, the location information contents service provides information according to the location of the terminal unilatelally, so that it has ben impossible to realize a service for electronically storing information created by the user such as a purchase memo on goods scheduled to be purchased, for example, through a network such that this information can be viewed at any desired location.

Also, in the location information contents service, it is possible to provide the information according to the location, but it has not been possible to provide appropriate information according to various properties of the individual user such as the user's preference. In addition, there has been no service for providing appropriate goods information according to information on the individual user such as goods that the individual user intends to purchase or preferred goods of the user.

Moreover, the location information contents service presupposes the narrow communication radius of the base station of the PHS, so that it has a limited availability as the information cannot be viewed from various information terminals other than the PHS terminal. Furthermore, the location information contents service requires the user to actively carry out an operation to make access to the contents in order to utilize the information so that it is tedious, and there has been no means for notifying appropriate information without requiring a user input so that situations in which this service can possibly be useful to the users are also rather limited.

Also, in the location information contents service, the location of the user is recognized but the actual state of the user at that location is not interpreted, so that it has been impossible to provide appropriate information according to the state of the user. In addition, in the location information contents service, the information is provided solely on the basis of the location so that it has been impossible to account for various other factors that can affect the information to be provided to the user both qualitatively and quantitatively such as the user's preference, the user's schedule, the time, etc.

On the other hand, the agent technique is associated with the following problems. First, the agent is generated and operated in response to the user's request, so that there is a need for the user to actively carry out the operation to send an information acquisition request to the agent in order to acquire the information and therefore it is also tedious. Also, the agent is generated at each occasion of the user's request specifically for a goal set by the user and the agent will disappear once the goal is achieved, so that there is no means for permanently maintaining various information of the user, and it has been difficult to provide the permanent services. Similarly, because the agent is not permanently existing, it has been impossible to constantly monitor the state of the user so that it easily loses many sales opportunities in the case of promoting purchases.

### BRIEF SUMMARY OF THE INVENTION

It is therefore an object of the present invention to provide a scheme for promoting purchases more effectively by utilizing characteristics of a computer network such as its ability to cover a wide area and support bidirectional communications.

According to one aspect of the present invention there is provided a purchase promotion server system, comprising: a user information database unit configured to store electronic goods/services information indicating goods/services scheduled to be purchased or goods/services desired to be purchased, for each user; a user state judgement unit configured to judge a user state of a user regarding whether the user is fit to purchasing of goods/services, according to state data including a location information of the user; and a user notification unit configured to send a message urging/reminding the user to purchase the goods/services scheduled to be purchased or the goods/services desired to be purchased indicated by the electronic goods/services information stored by the user information database unit, to the user via a network according to the user state of the user judged by the user state judgement unit.

According to another aspect of the present invention there is provided a purchase promotion method, comprising: storing electronic goods/services information indicating goods/services scheduled to be purchased or goods/services desired to be purchased, for each user; judging a user state of a user regarding whether the user is fit to purchasing of goods/services, according to state data including a location information of the user; and sending a message urging/reminding the user to purchase the goods/services scheduled to be purchased or the goods/services desired to be purchased indicated by the electronic goods/services information stored by the storing step, to the user via a network according to the user state of the user judged by the judging step.

According to another aspect of the present invention there is provided a computer usable medium having computer readable program codes embodied therein for causing a computer to function as a purchase promotion server system, the computer readable program codes include: a first computer readable program code for causing said computer to store electronic goods/services information indicating goods/services scheduled to be purchased or goods/services desired to be purchased, for each user; a second computer readable program code for causing said computer to judge a user state of a user regarding whether the user is fit to purchasing of goods/services, according to state data including a location information of the user; and a third computer readable program code for causing said computer to send a message urging/reminding the user to purchase the goods/services scheduled to be purchased or the goods/services desired to be purchased indicated by the electronic goods/services information stored by the user information database unit, to the user via a network according to the user state of the user judged by the user state judgement unit.

According to another aspect of the present invention there is provided a method for providing advertisement service, comprising: judging a user state of a user regarding whether the user is fit to purchasing of goods/services, according to state data including a location information of the user; producing contents according to the user state of the user judged by the judging step, by collecting related information relevant to a current location of the user indicated by the location information, the related information being an advertisement/recommendation of a shop existing in an area in which the user is currently located; and providing the contents produced by the producing step, in a form accessible by the user via the network.

Other features and advantages of the present invention will become apparent from the following description taken in conjunction with the accompanying drawings.

### BRIEF DESCRIPTION OF THE DRAWINGS

FIG. 1 is a table summarizing various elements involved in a purchase promotion system according to one embodiment of the present invention.

FIG. 2 is a schematic diagram showing an overall configuration of a purchase promotion system according to one embodiment of the present invention.

FIG. 3 is a block diagram showing an overall functional configuration of the purchase promotion system of FIG. 2.

FIG. 4 is a block diagram showing a detailed configuration of an agent service system in the purchase promotion system of FIG. 2.

FIG. 5 is a block diagram showing a detailed configuration of a goods information system in the purchase promotion system of FIG. 2.

FIG. 6 is a block diagram showing a detailed configuration of a shop's information terminal in the purchase promotion system of FIG. 2.

FIG. 7 is a block diagram showing a detailed configuration of a POS register in the purchase promotion system of FIG. 2.

FIG. 8 is a block diagram showing a detailed configuration of a portable telephone user system in the purchase promotion system of FIG. 2.

FIG. 9 is a block diagram showing a detailed configuration of an office user system in the purchase promotion system of FIG. 2.

FIG. 10 is a block diagram showing a detailed configuration of an Internet refrigerator in the purchase promotion system of FIG. 2.

FIG. 11 is a flow chart of a processing procedure for updating user information at an agent service system in the purchase promotion system of FIG. 2.

FIG. 12 is a flow chart of a processing procedure for stock management at an Internet refrigerator in the purchase promotion system of FIG. 2.

FIG. 13 is a flow chart of a processing procedure for purchase memo information input at an Internet refrigerator in the purchase promotion system of FIG. 2.

FIG. 14 is a flow chart of a processing procedure for sending located area information at a location information service unit in the purchase promotion system of FIG. 2.

FIG. 15 is a flow chart of a processing procedure for sending user information at an agent service system in the purchase promotion system of FIG. 2.

FIG. 16 is a flow chart of a processing procedure for sending goods information at a goods information service system in the purchase promotion system of FIG. 2.

FIG. 17 is a flow chart of a processing procedure for sending contents for user at an agent service system in the purchase promotion system of FIG. 2.

FIG. 18 is a flow chart of a processing procedure for displaying e-mail and WWW page at a portable telephone terminal in the purchase promotion system of FIG. 2.

FIG. 19 is a flow chart of a processing procedure for displaying contents at a shop's information terminal in the purchase promotion system of FIG. 2.

FIG. 20 is a flow chart of a processing procedure for sending requested contents at an agent service system in the purchase promotion system of FIG. 2.

FIG. 21 is a flow chart of a processing procedure for sending purchase information at a POS register in the purchase promotion system of FIG. 2.

FIG. 22 is a flow chart of a processing procedure for sending data of external application at an office user system in the purchase promotion system of FIG. 2.

FIG. 23 is a flow chart of a processing procedure for displaying user page at an office user system in the purchase promotion system of FIG. 2.

### DETAILED DESCRIPTION OF THE INVENTION

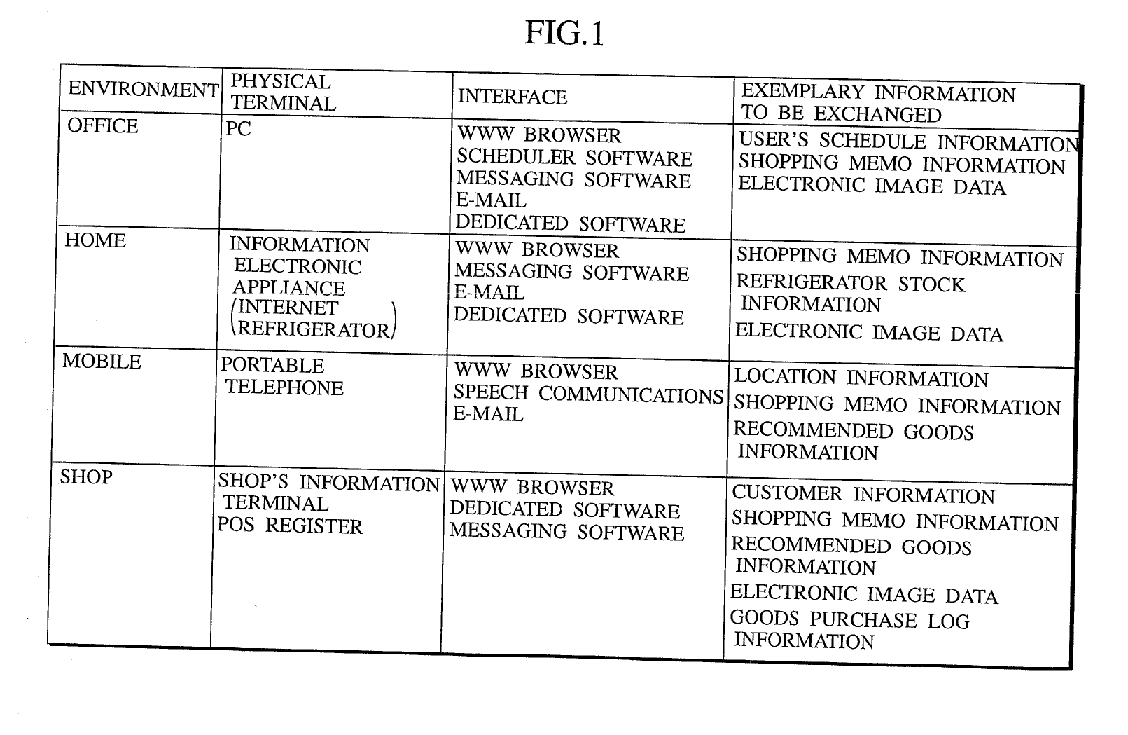

Referring now to FIG. 1 to FIG. 23, one embodiment of a scheme for promoting purchases according to the present invention will be described in detail. Note that, in the following description, terms such as “goods” or “goods scheduled to be purchased” will be used to indicate not only physical products but also services.

1. Outline

In recent years, in conjunction with the advances of the computer network such as the Internet and the diversification of devices for accessing the network and their utilization environments, there are demands for environments in which a user can access the network from various environments and utilize information or services in a unified way, regardless of whether the user possesses a terminal or not. Such environments are collectively referred to as a ubiquitous computing.

This embodiment uses a software that functions as a secretary called “agent” which supports efficient and easy accesses to information by the user in the ubiquitous computing world as described above.

The agent realizes a unified service for providing various services available on the network and various utilization environments connected to the network with respect to the user. Also, the agent realizes a personalized information service specific to the individual user. In other words, the agent is capable of sensing a current state of the individual user, automatically selecting various services according to the state of that moment, and selecting and processing information according to the user's preferences and providing it to the user. Such an agent will also be referred to as a ubiquitous personal agent.

Things to be judged by this agent includes a physical state of the user, i.e., where the user is currently located, such as hone, office, train, convenience store, amusement park, etc. Things to be judged by the agent also includes a current state of the user, i.e., what the user is currently doing, such as working, moving, shopping, etc. The agent can carry out various operations such as a notification of the schedule, a transfer of messages, a notification of an information on a remote place, a selection and retrieval of appropriate data according to the user information, a transportation of user's data, processing of information, an appropriate service providing, a change of interfaces, etc.

Namely, the purchase promotion system of this embodiment using the agent can be regarded as a shopping assisting agent system, which is a service system for supporting “shopping” activities through various scenes in the user's daily living by using applications realized on the ubiquitous personal agent.

In other words, the user can receive the information service suitable for the state and the preference of the user by using the “agent (secretary” service which has functions for managing various information of the user and the state of the user, and managing and controlling the information providing with respect to the user as summarized in FIG. 1, for example, through various terminals such as a PC of the home or the office, a portable telephone, an information terminal provided in the shop, etc.

2. Configuration

This embodiment is realized in forms of a purchase promotion system and a purchase promotion method to be executed on that system, or a computer usable medium recording the purchase promotion software.

2-1. Overall Configuration

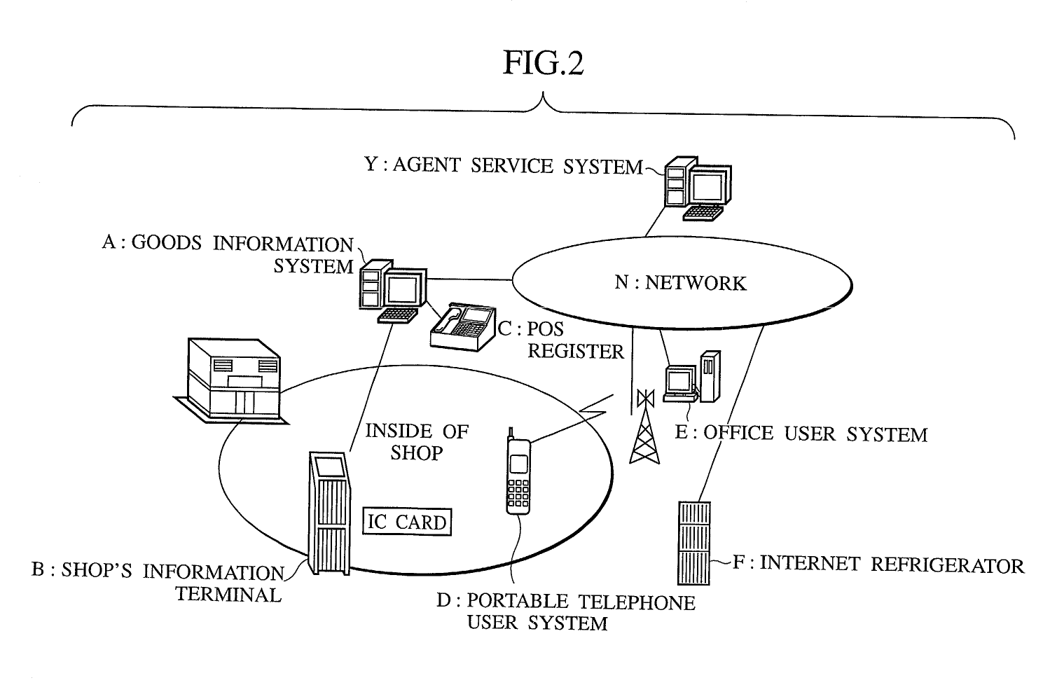

FIG. 2 shows an overall configuration of the purchase promotion system in this embodiment. This purchase promotion system comprises an agent service system Y for providing basic functions using the agent as described above, a goods information system A, a shop's information terminal B, a POS (Point Of Sale) register C, a portable telephone user system D including a portable telephone terminal and a portable telephone infrastructure unit, an office user system E, and an Internet refrigerator F, which are interconnected by a computer network N such as the Internet.

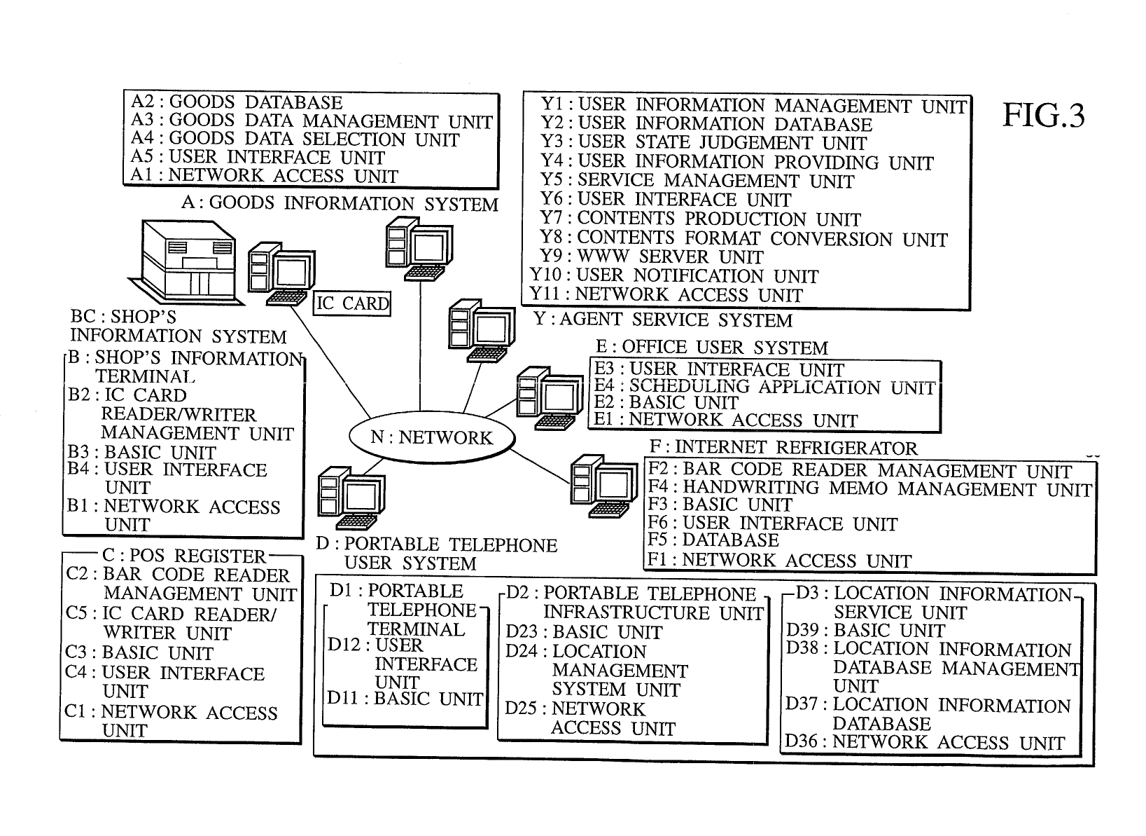

Also, as shown in the functional diagram of FIG. 3, the shop information terminal B and the POS register C are collectively referred to as a shop's information system BC. Moreover, the portable telephone user system D includes a location information service unit D3 in addition to the portable telephone terminal D1 and the portable telephone infrastructure unit D2.

2-2. The Agent Service System Y

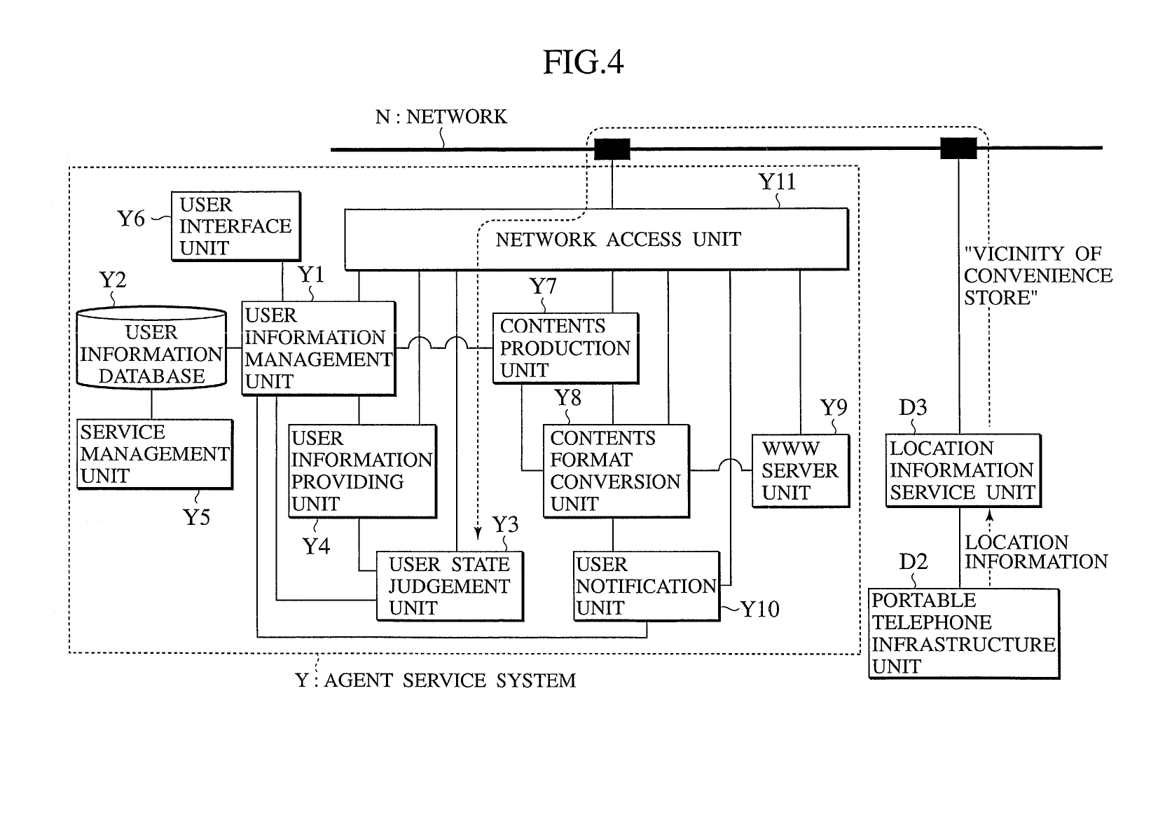

The agent service system Y is a core of this purchase promotion system, which is a server system for realizing the agent service whose basic functions are provided by the following constituent elements as shown in FIG. 3 and FIG. 4.

First, a user information management unit Y1 is a unit for storing and managing various user information, which stores electronic goods information indicating goods scheduled to be purchased or goods desired to be purchased for each user, into the server system on the computer network. Also, the user information management unit Y1 recognizes a type of information communication terminal currently used by the user corresponding to the electronic goods information.

Also, a user information database Y2 is a database for storing user information such as the electronic goods information for each user. In this purchase promotion system, the electronic goods information may be shared by a plurality of users.

Also, the user information management unit Y1 updates at least one of the purchase log and the electronic goods information of each user by obtaining information on goods actually purchased by each user from the POS register C of the shop's information system BC (see FIG. 3).

Also, a user state judgement unit Y3 receives input of state data indicating various states of the user at that moment from the network N for example, constantly monitors them, and judges the state of user from these state data.

Here, the state data indicating various states of the user are data varying in real time such as a location of the user, facilities located in a vicinity of the user's location, time, etc. These state data are to be interpreted by utilizing interpretation data that are prepared in advance for the purpose of interpreting the state data. The actual contents of the interpretation data are optional, and may include a located area information indicating facilities located in a vicinity of each set of latitude and longitude, a schedule information registered by the user in advance, a utilized terminal information indicating a type of information communication terminal utilized by the user, an activity log indicating the user's working time zone, etc., for example.

Note that the interpretation data such as the located area information and the interpretation function for identifying facilities in a vicinity of a set of latitude and longitude according to this located area information may be provided at the agent service system Y, or at the other unit such as the portable telephone user system D. In this embodiment, the located area information and the interpretation function for identifying facilities in a vicinity of a set of latitude and longitude according to this located area information are assumed to be provided at the location information service unit D3 of the portable telephone user system D (see FIG. 3).

Also, when the user passes by a convenience store and the purchase memo information is registered as the user information, the state of “passing near a convenience store” is judged, With respect to such an information on the user's state, appropriate user information is selected and provided via the network to the user. Also, the user's state is sequentially stored as a part of the user information at the user information database Y2.

Also, a user information providing unit Y4 is a unit for providing appropriate user information according to the user's state to the external, where only the information related to each user's state is provided in this case. Also, the user information providing unit Y4 can set an access limit for limiting destinations for providing information, such that which user information can be provided to which external system (for example, the name and address are not to be provided and only the purchase memo information is to be provided) can be defined in detail.

This user information providing unit Y4 can also enable the user to view the electronic goods information via the network N at the information communication terminal, or notify information containing the electronic goods information to the information communication terminal recognized by the user information management unit Y1. The user information providing, unit Y4 can also collect information to be provided to the user according to the user's state judged by the user state judgement unit Y3 and provide the collected information to the user.

Also, a service management unit Y5 carries out processing regarding management of services such as registration for various services provided on the network that the user wishes to utilize. This service management unit Y5 enables the user to limit a range for providing the user information. This service management unit Y5 can also set up in advance a way of providing the collected information to the user, where this setting can also be made by the user. Then, the service registration state and the setting regarding a way of providing the collected information to the user are registered as a part of the user information in the user information database Y2.

Also, in the agent service system Y, the information processing including at least the storing and presentation processing of the electronic goods information is carried out by an agent corresponding to each user.

Also, a user interface unit Y6 has a management interface for a function for viewing information managed by the user information database Y2 or various other functions for the sake of a manager.

Also, a contents production unit Y7 produces contents in a format suitable to the user, based on information intended for a specific user that is produced by system other than the agent service system Y such as the goods information system A and provided via the network, such as a recommended goods information of a located dependent advertisement information, for example. These contents are produced in a display terminal independent format such as XML format.

Then, the contents information produced by the contents production unit Y7 that is described in the display terminal independent format is converted into a format suitable to the display terminal, such as the HTML format on the WWW browser or a text format on the e-mail, at a contents format conversion unit Y8. Also, the contents in the HTML format (including subset such as CompactHTML format) that are produced by the contents production unit Y7 and converted by the contents format conversion unit Y8 are provided as a WWW page by a WWW server unit Y9.

Also, a user notification unit Y10 realizes a real time notification with respect to the user. Here, the real time notification can be realized in a plurality of ways using an e-mail, a subscriber telephone, an instant messeging software, etc. The user notification unit Y10 selects the appropriate way of notification and transmits a message according to the current state of the user as managed by the user information management unit Y1, such as the state in which the user is located outdoor and carrying a portable telephone, for example. Here, it is assumed that the mail transmission to the portable telephone terminal will be used for the real time notification.

Also, a network access unit Y11 carries out exchange of data and transmission/reception of events, with respect to the other units via the network N.

2-3. The Goods Information System A

Next, the goods information system A is a system managed by a convenience store or a supermarket, for providing goods data according to the preference and the purchase log of the user through the network N using the following constituent elements as shown in FIG. 3 and FIG. 5.

First, a gods database A2 is a database such as Access or Oracle for managing goods data. As a format of this goods data, each record can be formed by a classification, a bar code information, a goods name, a price, etc., for example, but the specific format can be determined freely according to the factors related to the operation of this purchase promotion system. Also, a goods data management unit A3 manages the goods database A1 by carrying out registration, retrieval, deletion, etc., of data.

Also, a goods data selection unit A4 selects appropriate goods information according to the user profile acquired from the network N. The user profile to be used in this selection may contain an age, a sex, a job, a preferred goods information, a past goods purchase log, a purchase memo information, etc. Also, the goods information to be selected can be one or plural depending on the state. Also, the log of the selection can be an information to be stored and provided to the network N.

Also, a user interface unit A5 is a user interface for managing the goods information system A which is a subsystem, which has necessary functions such as management of the database and viewing of the goods selection state or the user information. Also, a network access unit A1 carries out exchange of data and transmission/reception of events, with respect to the other units via the network N.

2-4. The Shop's Information System BC

The Shop's information system BC has the shop's information terminal B and the POS register C as shown in FIG. 3.

2-4-1. The Shop's Information Terminal

The Shop's information terminal B is an information terminal provided inside the shop or on a PC which is provided with hardware such as a touch panel display or an IC card reader/writer, for displaying the goods information specific to the user as obtained by the agent of the user. In this case, the goods information is transmitted from the goods information system A through the network N, and the goods information to be displayed is acquired from the network N.

Also, the shop's information system BC utilizes an IC card for the acquisition of the individual ID. Namely, when the user inserts the IC card, the shop's information system BC identifies the individual and carries out the acquisition and display of the information intended for the identified user.

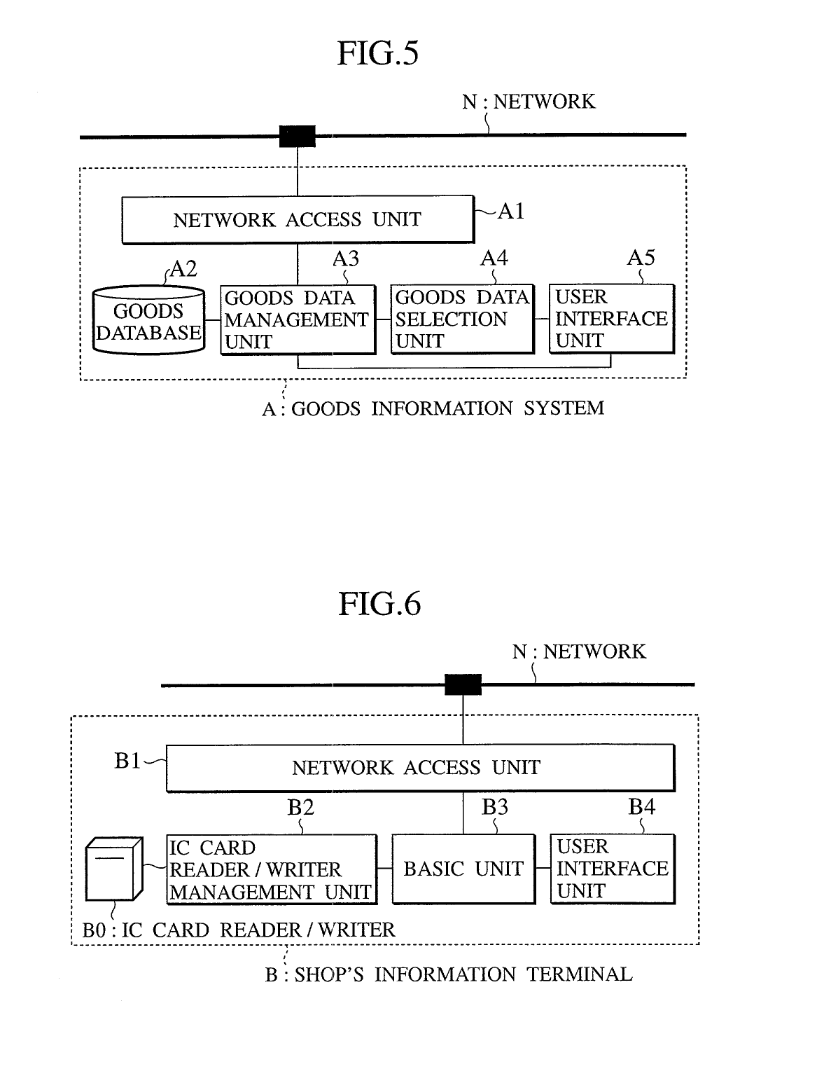

The shop's information terminal B as described above has the following constituent elements as shown in FIG. 3 and FIG. 6.

First, an IC card reader/writer management unit B2 carries out reading/writing of IC card for the purpose of the user authentication by using an IC card reader/writer B0. Also, a basic unit B3 carries out basic functions to be provided on the shop's information terminal B such as those of ticket reservation, goods information providing, etc., for example, as well as basic operations for the shopping assisting system. The base unit B3 also controls the identification of the user, the acquisition and display of the information, etc., in cooperation with the other units via the network N.

Also, a user interface unit B4 displays the goods information acquired from the network N. Here, the actual display format can be selected from options such as WWW, dedicated application, etc. Also, in the case of using WWW, the contents are provided by providing a separate WWW server. Also, a network access unit B1 carries out exchange of data and transmission/reception of events, with respect to the other units via the network N. Note that the shop's information terminal B can be formed integrally with various monitoring TV or multimedia terminals.

2-4-2. The POS Register C

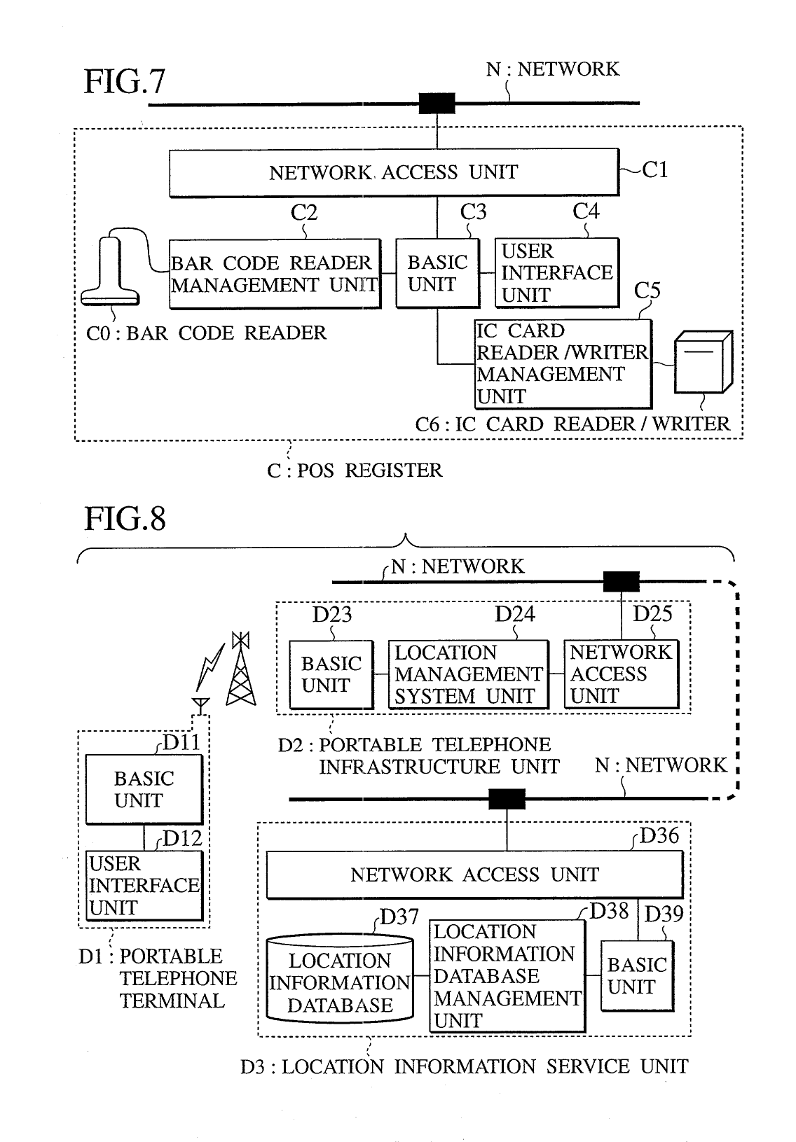

The POS register C has a function for providing the goods purchase log of each user with respect to the network N in addition to the usual POS register functions, and has the following constituent elements as shown in FIG. 3 and FIG. 7.

First, a bar code reader management unit C2 inputs a bar code printed on the goods by using a bar code reader C0 and utilizes it as 13 digit number of JAN (Japan Article Number) code or the like. Also, the IC card reader/writer management unit CS carries out reading/writing of the IC card for the purpose of the user authentication by using an IC card reader/writer C6. Also, a basic unit C3 realizes the POS register functions and manages the goods data formed by JAN code, price, goods name, etc., and the purchase data formed by user ID, JAN code, etc. This purchase data is provided to the network N.

Also, a user interface unit C4 realizes the POS register functions and has interfaces for the goods code input, the calculation processing, and the user information viewing. Also, a network access unit C1 carries out exchange of data and transmission/reception of events, with respect to the other units via the network N.

2-5. The Portable Telephone User System D

As shown in FIG. 3 and FIG. 8, the portable telephone user system D is formed by the portable telephone terminal D1, the portable telephone infrastructure unit D2 for realizing the portable telephone service, and the location information service unit D3 for providing the located area information according to the location information of the portable telephone terminal D1 that is provided from the portable telephone infrastructure unit D2 such as a set of latitude and longitude, for example.

2-5-1. The Portable Telephone Terminal D1

The portable telephone terminal D1 has a user interface unit D12 and a basic unit D11 as shown in FIG. 3 and FIG. 8. The user interface unit D12 is a user interface of the telephone itself which has display functions such as e-mail display screen, WWW browser screen, etc., in addition to the various interfaces for the usual speech communications. Also, the basic unit D11 realizes the various functions of the portable telephone such as speech communications, data communications, e-mail transmission/reception, WWW page viewing, etc., for example.

2-5-2. The Portable Telephone Infrastructure Unit D2

The portable telephone infrastructure unit D2 provides the infrastructure for realizing the portable telephone service, such as a portable telephone network, base stations, a portable telephone terminal location management mechanism, etc., so that it is possible to manage the location of the portable telephone by latitude and longitude information. This location management mechanism is realized by the following constituent elements as shown in FIG. 3 and FIG. 8.

First, a basic unit D23 is a unit for acquiring the location information, i.e., latitude and longitude and providing it along with the user ID. Also, a location management system unit D24 manages a location of the portable telephone terminal D1, where the location information is managed in terms of latitude and longitude. Also, a network access unit D25 carries out exchange of data and transmission/reception of events, with respect to the other units via the network N.

2-5-3. The Location Information Service Unit D3

The location information service unit D3 refers to the correspondence data between the latitude and longitude information and the located area information stored in a location information database D37 according to the location information formed by latitude and longitude information provided by the location management system unit D24, extracts the located area information corresponding to the current location of the user, such as a convenience store, a shop, a company building, a railway station, etc., to the network N.

This location information service unit D3 has the following constituent elements as shown in FIG. 3 and FIG. 8. Namely, a basic unit D39 carries out the conversion of the location information into the located area information by matching the latitude and longitude information and the located area information. Also, the location information database D37 stores the correspondence data between the latitude and longitude information and the located area information. Also, the location information database management unit D38 carries out the management of the location information database unit D37. Also, a network access unit D36 carries out exchange of data and transmission/reception of events, with respect to the other units via the network N.

2-6. The Office User System E

The office user system E is a system to be used by the user in the office, which enables the execution of registration, updating, etc., of various user information through the user interface, and has a coordination function for providing various data of various external applications on the office PC to the agent service system Y so as to enable their utilization as a part of the user information provided.

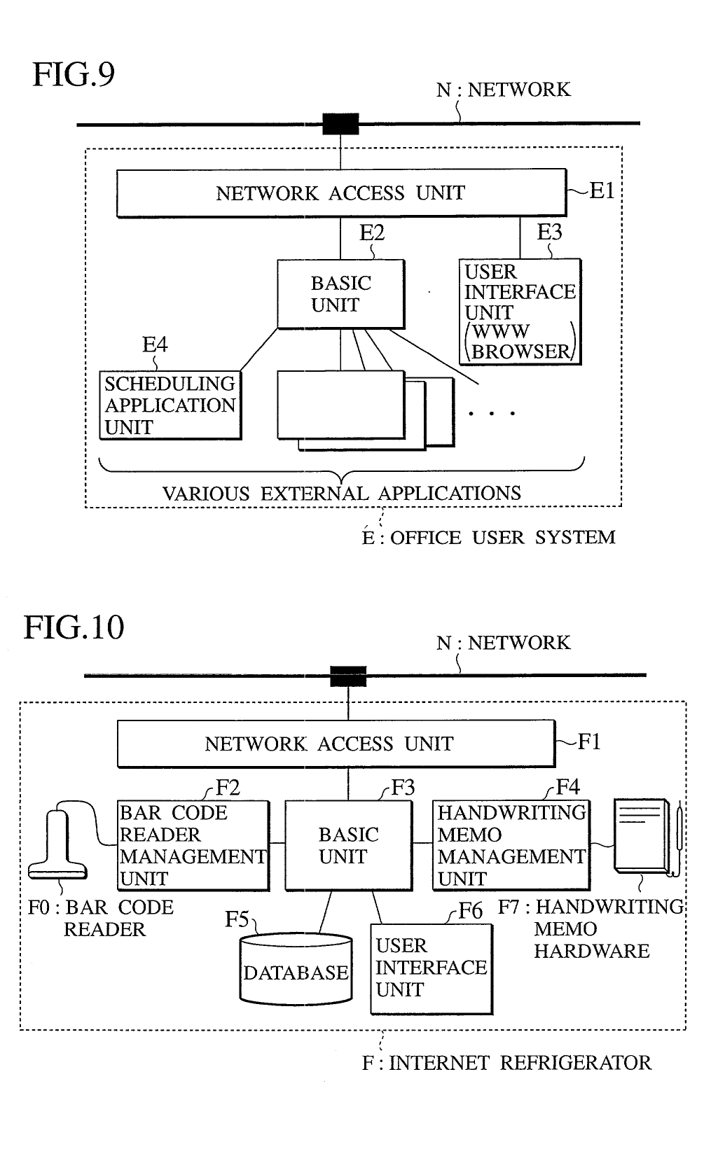

This office user system E has the following constituent elements as shown in FIG. 3 and FIG. 9. Namely, a user interface unit E3 has a WWW browser, where the contents intended for the user that are to be displayed at the user interface unit E3 are provided by the WWW server unit Y9 of the agent service system Y. Also, the scheduling application unit E4 is an example of the various external applications, for registering and managing various user information such as the schedule information.

Also, a basic unit E2 coordinates the various external applications operating on the office PC such as the scheduling application unit E4 with this purchase promotion system, where data acquired from the various external applications are transmitted to the agent service system Y through a network access unit E1. Namely, the network access unit E1 carries out exchange of data and transmission/reception of events, with respect to the other units via the network N.

2-7. The Internet Refrigerator F

In this purchase promotion system, the out-of-stock goods information based on the stock management using the stock registration in the refrigerator is also provided to the user either as a part of the electronic goods information or separately from the electronic goods information. Namely, the Internet refrigerator F is provided integrally with a refrigerator or as an associated equipment of the refrigerator, and has a function of a home information terminal to be utilized by the user at home, a function for managing various information on the refrigerator, and a function for providing the various information to the other units through the network N.

Also, the Internet refrigerator F is connected with hardware such as a bar code reader FO and a handwriting memo hardware F7, and has a function for managing foods in the refrigerator based on the bar code reading, a function for recognizing handwritten memo, and a function for providing the purchase memo information based on the stock information of the refrigerator and the handwritten memo to the agent service system Y, etc., via the network N.

Namely, the Internet refrigerator F has the following constituent elements as shown in FIG. 3 and FIG. 10. First, a bar code reader management unit F2 carries out the recognition of foods entered into or taken out from the refrigerator by using the bar code reader F0. Also, the handwriting memo management unit F4 recognizes handwritten characters written by using the handwriting memo hardware F7, and converts it into the purchase memo information by using the handwritten character recognition technique such as the pattern matching.

Also, a user interface unit F6 is an interface for enabling viewing of the refrigerator stocked foods information or the handwritten memo information. Also, a database F5 stores information such as the refrigerator stock information and the purchase memo information. Also, a network access unit F1 carries out exchange of data and transmission/reception of events, with respect to the other units via the network N.

Note that the information to be provided to the user is not necessarily limited to the out-of-stock information related to the refrigerator, and can be an out-of-stock information based on the foods consumption amount based on the cooking recipe executed by the microwave oven, a new product information based on the preference information extracted from the past purchase log, or any desired combination of these.

3. Operation

Now, the operation of the purchase promotion system according to this embodiment as described above will be described along some concrete scenarios for exemplary scenes where the user utilizes this purchase promotion system.

3-1. Scenario I

(In Advance)

The user registers basic personal information after subscribing to a service provided by the agent of this purchase promotion system. The personal information contains types of goods of interest, an e-mail address or a telephone number of a portable telephone terminal with the Internet access function that is usually used by the user, a working time zone, etc. Also, as the user utilizes the service, information such as the past purchase log and information on frequently visited shops will be stored in the agent service system Y as a part of the user information.

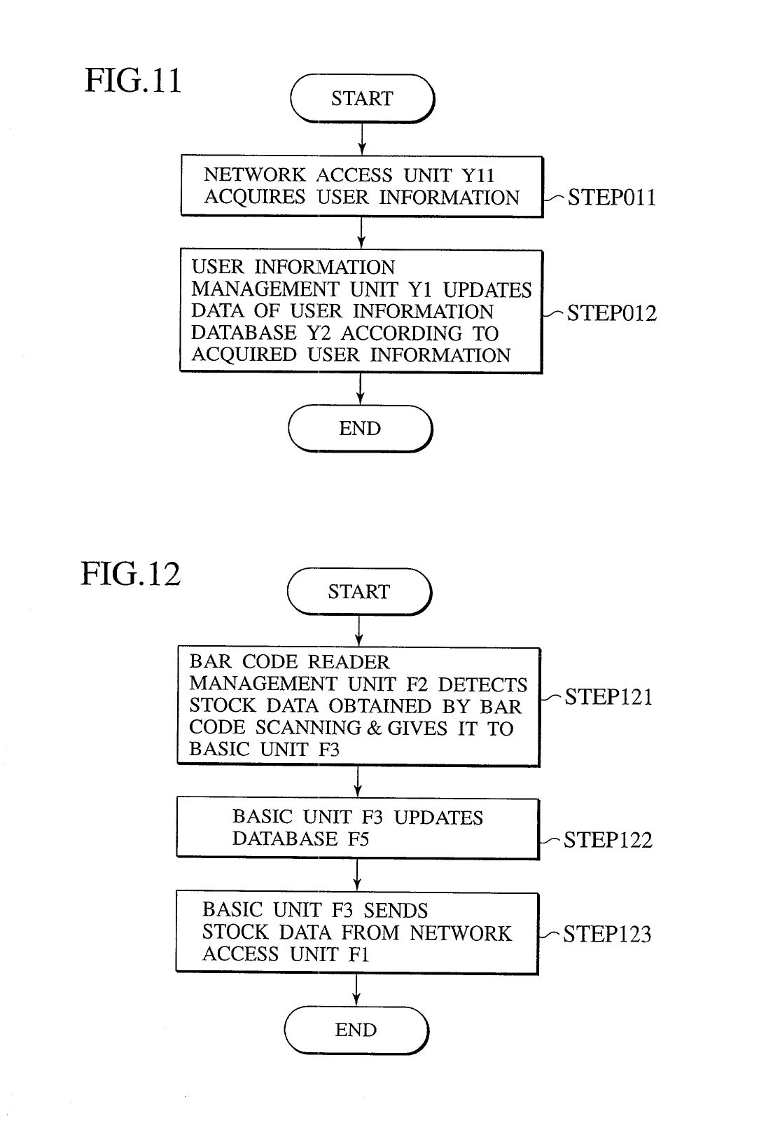

Here, the user information is updated according to the procedure shown in FIG. 11, for example. Namely, when the network access unit Y11 acquires the new user information 8 step 011), the user information management unit Y1 updates the user information stored in the user information database Y2 according to the acquired user information (step 012).

(At Home)

For example, at the Internet refrigerator F of the home, the user scans the bar code at a time of taking out the milk from the refrigerator such that the Internet refrigerator F obtains information that the milk stocked in the refrigerator is taken out and out-of-stock. This out-of-stock information is sent to the agent service system Y via the network N and the user information is updated (the out-of-stock information is updated).

This is done according to the procedure shown in FIG. 12, for example. Namely, when the bar code reader management unit F2 detects the stock data generated by the bar code scan using the bar code reader F0 and gives it to the basic unit F3 (step 121), the basic unit F3 updates the database for the stock data or the like in the database unit F5 (step 122), and the stock data or the out-of-stcok information is sent from the network access unit F1 (step 123).

Also, when the user recall that there is a need to buy salad oil and writes “salad oil” into the purchase memo through the handwriting memo hardware F7 on the Internet refrigerator F, the Internet refrigerator F converts the user input characters into text data by using the handwriting recognition function and sends that purchase memo information to the agent service system Y via the network N, such that the purchase memo information managed by the agent service system Y is updated.

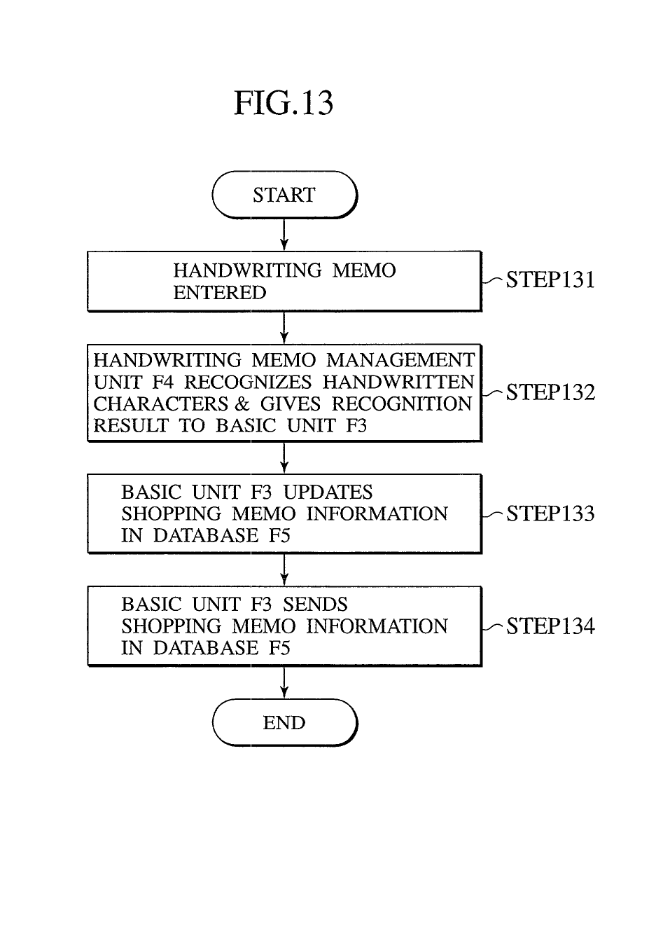

This is done according to the procedure shown in FIG. 13, for example. Namely, when the handwritten memo is entered at the handwriting memo hardware F7 (step 131), the handwriting memo management unit F4 carries out the handwritten character recognition and gives its result to the basic unit F3 (step 132). Then, the basic unit F3 updates the database of the purchase memo information or the like in the database unit F5 (step 133). Also, the basic unit F3 sends the purchase memo information in the database unit F5 to the agent service system Y, for example (step 134).

(While Moving Outdoor)

When the user moving outdoor possesses the portable telephone, the location information of the terminal is constantly provided to the location information service unit D3 by the location management function of the portable telephone infrastructure unit D2, and the location information service unit D3 provides the located area information indicating what kind place the user is currently located, as the state data with respect to the agent service system Y.

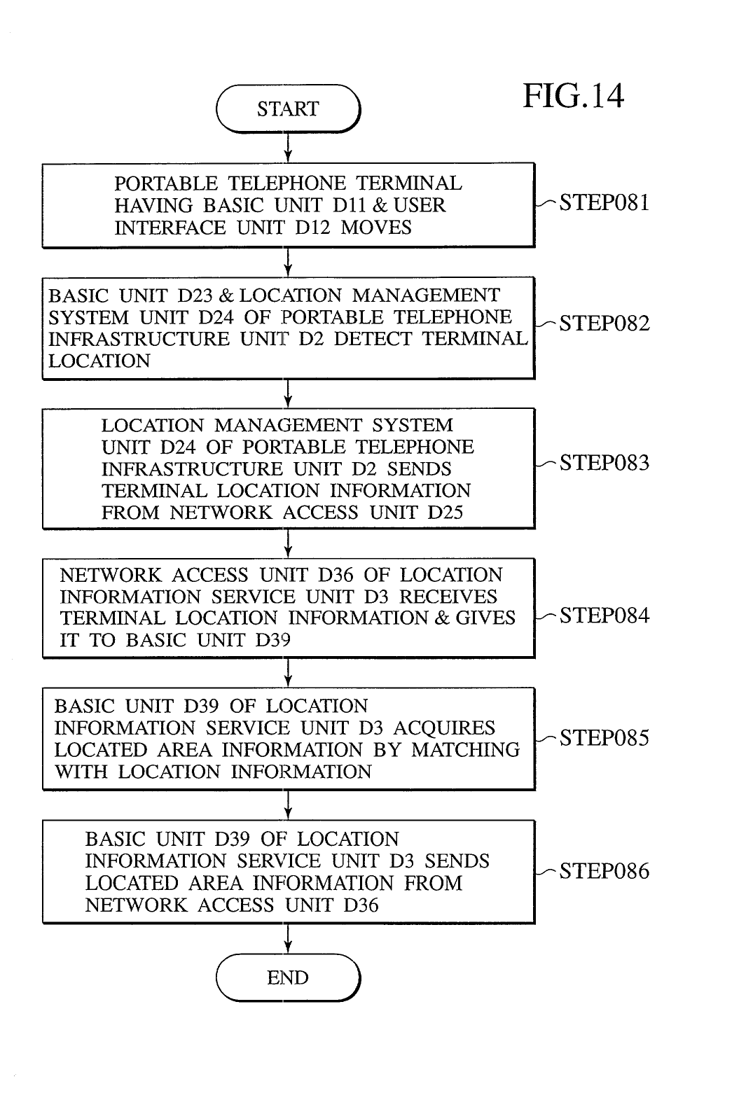

This sending of the located area information due to the terminal movement is done according to the procedure shown in FIG. 14, for example. Namely, when the portable telephone terminal D1 having the basic unit D11 and the user interface unit D12 moves (step 081), the basic unit D23 and the location management system unit D24 of the portable telephone infrastructure unit D2 detect the terminal location at constant period (step 082). Then, the location management system unit D24 of the portable telephone infrastructure unit D2 sends the terminal location information indicating the terminal location from the network access unit D25 toward the location information service unit D3 (step 083).

At the location information service unit D3, the network access unit D36 receives this terminal location information, and gives it to the basic unit D39 (step 084). Then, the basic unit D39 and the location information database management unit D38 of the location information service unit D3 searches through the location information database D37 and acquires the corresponding located area information from the located area information indicating facilities in vicinity of each set of latitude and longitude (step 085). Then, the located area information so obtained is sent from the network access unit D36 by the basic unit D39 of the location information service unit D3 (step 086).

When the user moving in this way passes in front of a convenience store, the agent service system Y that acquired the located area information indicating that the location is in vicinity of a convenience store from the location information service unit D3 judges the state as that of “passing in vicinity of a convenience store” (see FIG. 4), and accordingly the user information providing unit Y4 inside the agent service system Y selects and provides the user information corresponding to the state of “passing in vicinity of a convenience store”.

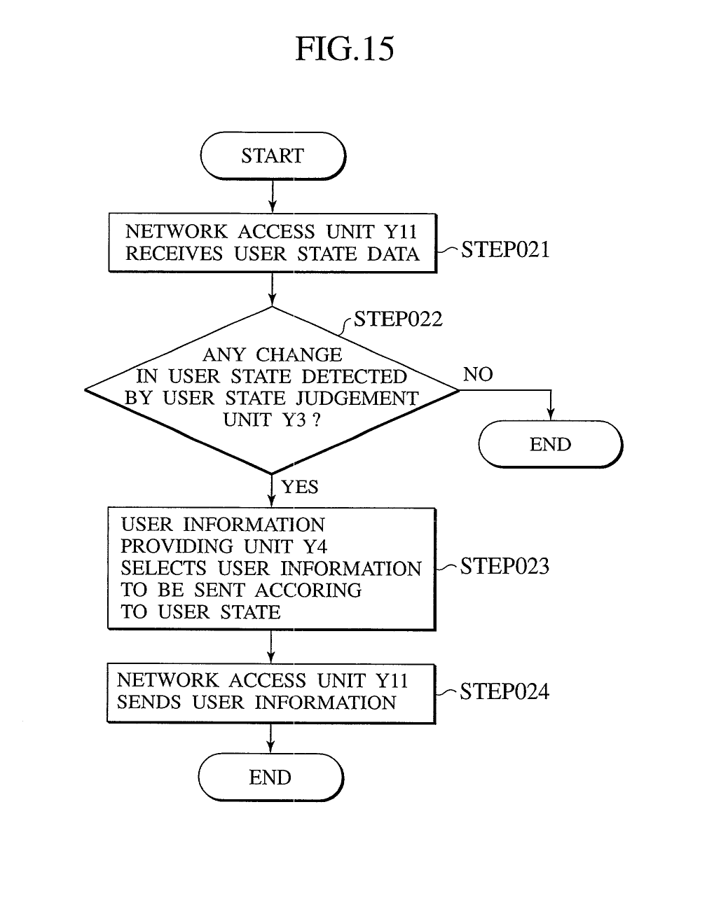

This sending of the user information according to the state change is done according to the procedure shown in FIG. 15, for example. Namely, when the network access unit Y11 of the agent service system Y receives the state data of the user (step 021), the user state judgement unit Y3 judges whether there is any change in the user state or not (step 022), and if there is a change, the user information providing unit Y4 selects the user information (transmission user information) to be sent according to the user state (step 023), and the network access unit Y11 sends this user information (step 024).

Here, four informations including the purchase memo information, the refrigerator out-of-stock information, the past purchase log, and the purchase preference information will be provided from the user information. Here, it is possible to send the user information directly only to the user, but it is preferable to send it once toward the goods information system A of the related service provider, and also send the recommended goods information returned in response, to the user. In such a case, the information providing destination is determined according to the access limitation set in advance and the state content, such as that indicating which convenience chain store it is that the user is passing by, for example. Here, the information is provided with respect to the goods information system A of the corresponding convenience chain store.

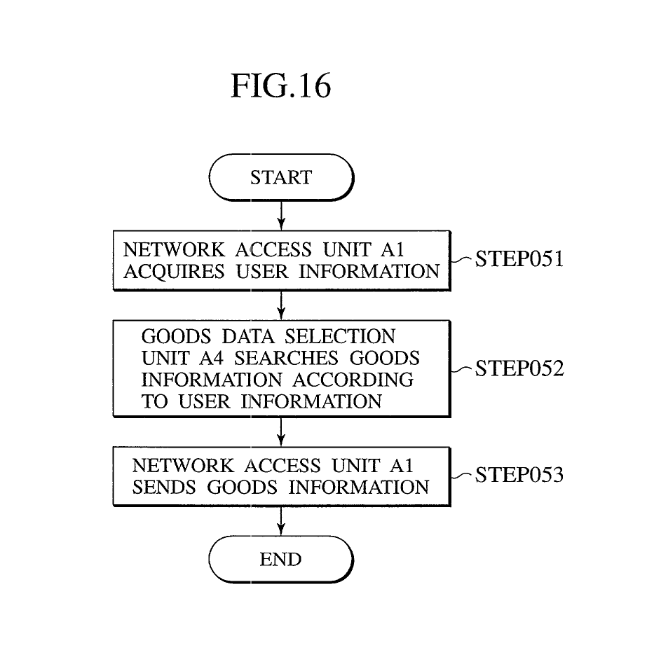

When the user information is provided, the goods information system A operates according to the procedure shown in FIG. 16, for example. Namely, when the network access unit A1 acquires the user information (step 051), the goods data selection unit A4 carries out a search of the recommended goods information suitable for this user among the goods information according to that user information (step 052), and the goods information so obtained is sent from the network access unit A1 to the agent service system Y as the information intended for the user (step 053).

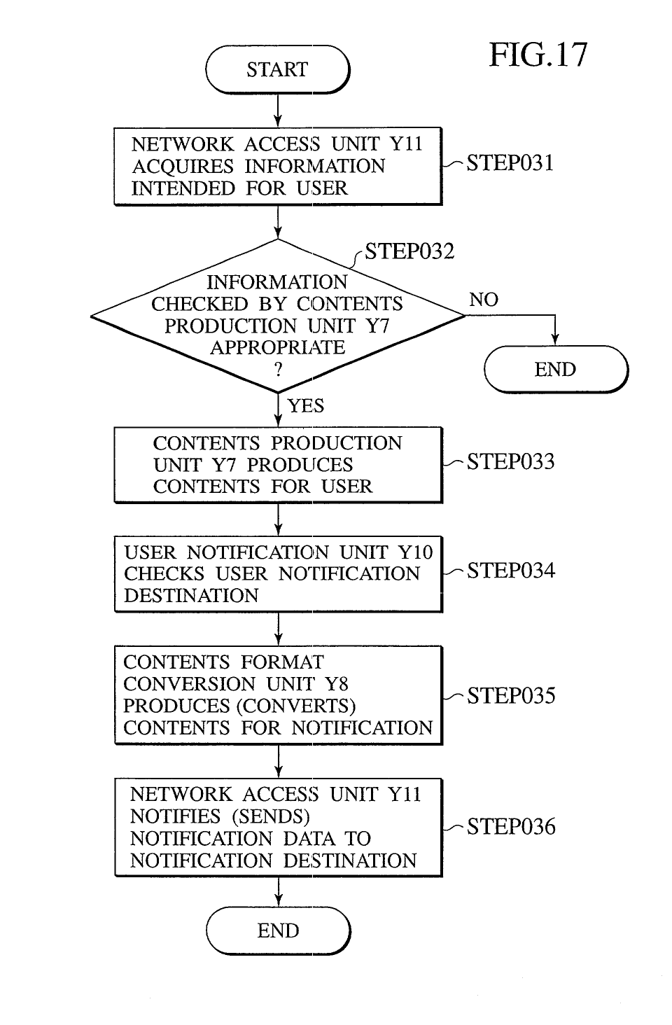

When the information intended for the user is provided from the external such as the goods information system A in this way, the agent service system operates according to the procedure shown in FIG. 17, for example. Namely, when the network access unit Y11 acquires the provided information intended for the user (step 031), whether that information is appropriate for the user or not is checked at the contents production unit Y7 (step 032). For this check, various data in the user information database can be utilized. For example, whether or not the goods corresponding to the contents described in the purchase memo information of the user are recommended in the provided information or not is checked.

Then, the contents production unit Y7 in the agent service system Y produces the contents intended for the user according to the information judged as appropriate for the user as a result of the check (step 033). The contents so produced are converted into appropriate format whenever necessary by the contents format conversion unit Y8 according to the information access environment (portable telephone or shop's information terminal) of the user, so as to produce the contents for notification.

Namely, in order to notify the user that the new contents are provided by the agent, the user notification unit Y10 in the agent service system Y refers to the information in the user information management unit Y1 and determines appropriate user notification destination (step 034). For example, when the acquired information indicates that the user is currently located outdoor and has a portable telephone, the user notification unit Y10 selects the mail transmission to the portable telephone. Then, the contents produced by the contents production unit Y7 are converted into a format of the e-mail at the contents format conversion unit Y8 (step 035), and the contents for notification in the e-mail format are sent from the network access unit Y11 to the portable telephone that is the notification destination.

(User Notification, E-mail Reception at the Portable Telephone)

In the above described case, the user who is walking outside suddenly receives a message (e-mail) from the agent of the agent service system Y at the portable telephone. In this e-mail, the user can view a message for urging the purchase such as “You sure you are not forgetting to buy something?” or “You can buy goods on your purchase memo at a nearby convenient store.” as well as the user's purchase memo (on which “salad oil” is described). Also, when the user clicks on a link (URL) labelled “Recommended goods from the convenience store” on the e-mail, the user can view the WWW page showing, the recommended goods information provided from the goods information system A. In this case, the user is viewing the contents that are converted into the WWW contents suitable for the portable telephone.

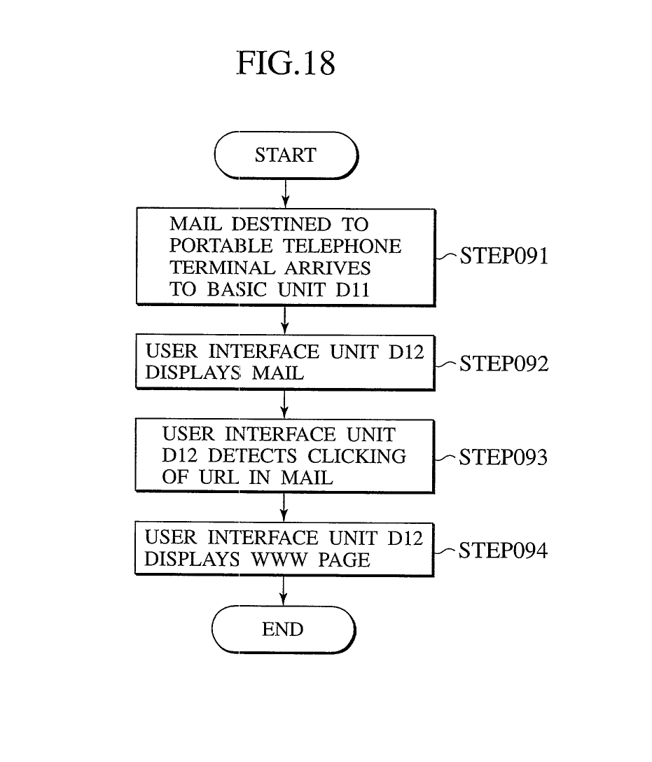

In the case of receiving and viewing the e-mail destined to the portable telephone and viewing the WWW page as described above, the portable telephone terminal D1 operates according to the procedure shown in FIG. 18, for example. Namely, in the portable telephone terminal D1, when the e-mail destined to the portable telephone arrives to the basic unit D11 (step 091(, the user interface unit D12 displays the e-mail (step 092). Also, when the user interface unit D12 detects the clicking of the URL in the e-mail by the user (step 093), the user interface unit D12 displays the corresponding WWW page (step 094).

The contents to be viewed at the portable telephone terminal D1 in this way may be those produced in the specific HTML format in advance, or the goods information provided from the goods information system A or the like that is converted by the contents format conversion unit Y8 of the agent service system Y at each occasion.

(Entering Shop, Access to the Shop's Information Terminal)

The user who entered into that convenience store upon seeing the notification as described above can utilize the shop's information terminal B which is an information terminal provided inside the shop. In this case, when the user authentication is carried out first as the user inserts the IC card into the IC card reader/writer provided on the shop's information terminal B, a menu specifically intended for the user is displayed on the screen. When a “shopping list check” option is selected from this menu, for example, the shop's information terminal B requests the agent service system Y to provide the contents, and the agent service system Y produces and converts the contents suitable for the shop's information terminal B. The shop's information terminal B then displays the acquired contents.

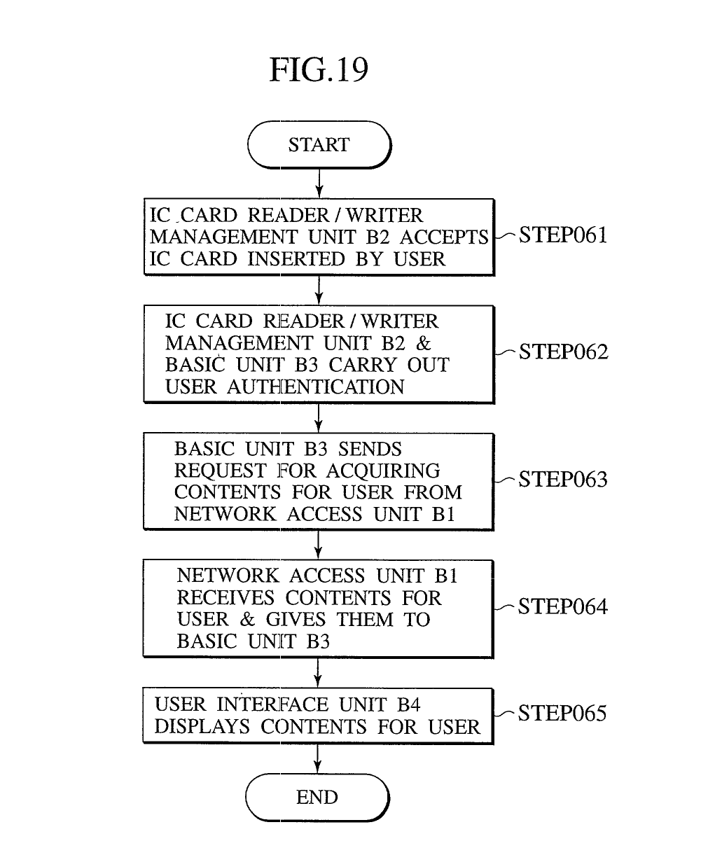

More specifically, the shop's information terminal B operates according to the procedure shown in FIG. 19, for example. Namely, in the shop's information terminal B, when the IC card reader/writer management unit B2 accepts the IC card inserted by the user (step 061), the IC card reader/writer management unit B2 and the basic unit B3 carry out the user authentication (step 062), and the basic unit B3 sends a request for acquiring contents intended for the user from the network access unit B1 to the network access unit C1 (step 063).

Then, when the network access unit B1 receives the contents intended for the user in response to the contents acquisition request and gives them to the basic unit B3 (step 064), the user interface unit B4 displays the contents intended for the user in response to a command from the basic unit B3 (step 065).

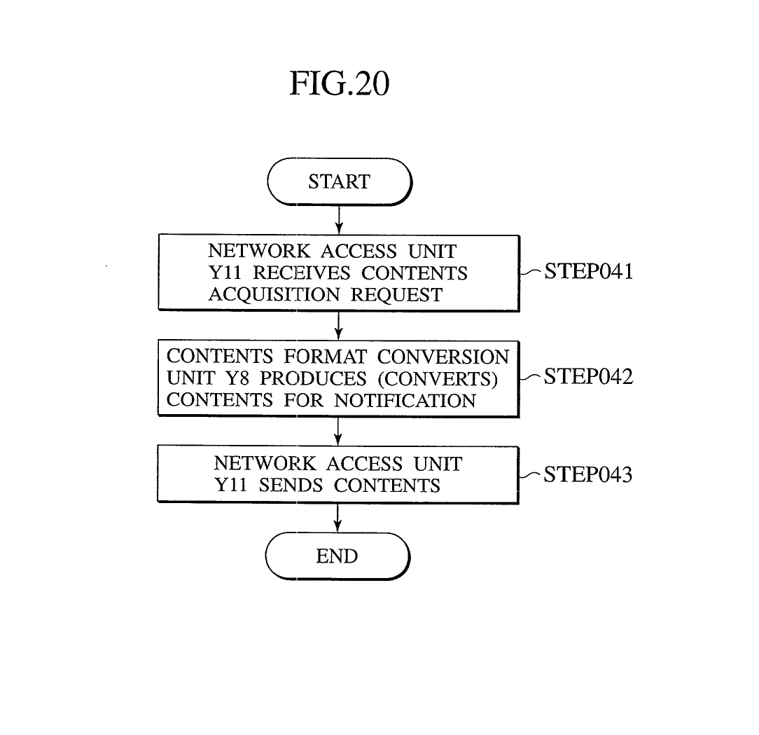

On the other hand, with respect to the contents acquisition request described above, the agent service system Y operates according to the procedure shown in FIG. 20, for example. Namely, when the network access unit Y11 receives the contents acquisition request (step 041), the contents format conversion unit Y8 converts the contents into contents for notification (step 042), and the network access unit Y11 sends the data of the converted contents to the request source (step 043).

On the shop's information terminal B, the displayed contents contain more information than those displayed on the portable telephone terminal D1 because of the larger display screen. More specifically, for example, in addition to the purchase memo information and the recommended goods information corresponding to the purchase memo that can also be viewed on the portable telephone terminal D1, it is possible to display the out-of-stock information from the internet refrigerator F and the corresponding recommended goods information, the recommended goods information based on the past purchase log, the recommended goods information based on the user's preference information, the shop layout diagram indicating arranged location of the recommended goods inside the shop, etc.

(Purchasing)

The user selects some goods in that convenient store and proceeds to the calculation at the POS register C. At the time of carrying out the calculation at the POS register C, the user authentication using the IC card is carried out first in order to identify the user. Then, the POS register C carries out the calculation processing, and provides the information on goods purchased by the user to the agent service system Y via the network N such that the purchase log information of that user is updated. Also, the matching with the purchase memo information is taken, and the purchased goods are deleted from goods registered in the purchase memo information.

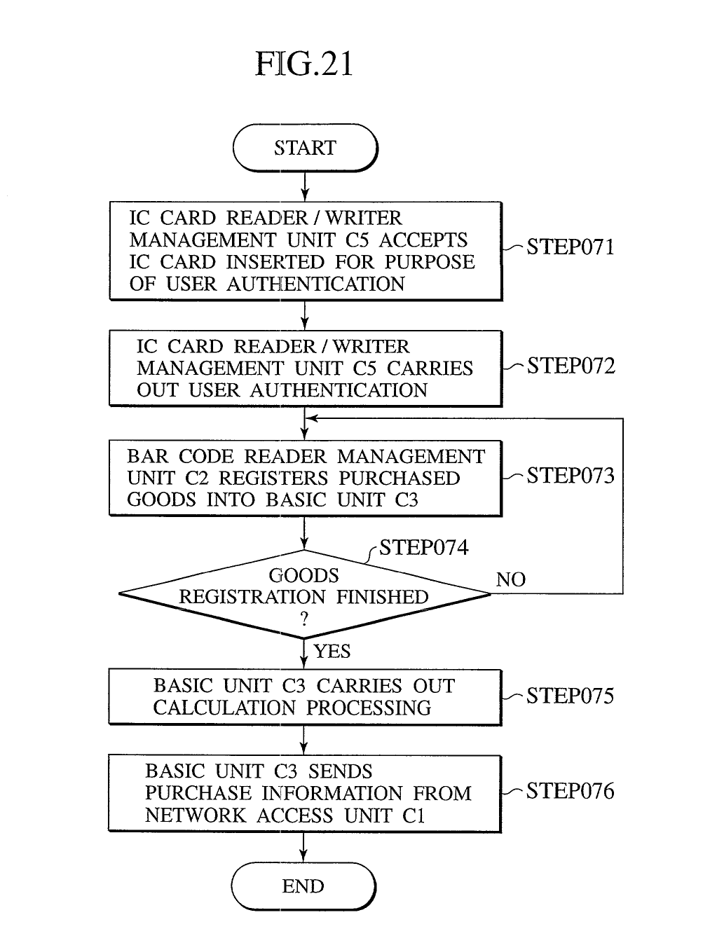

In the case of sending the information on purchased goods (purchase information) from the POS register C to the agent service system Y as described above, the POS register C operates according to the procedure shown in FIG. 21, for example. Namely, in the POS register C, when the IC card reader/writer management unit C5 accepts the IC card inserted by the user (step 071), the IC card reader/writer management unit C5 carries out the user authentication (step 072), and the bar code reader management unit C2 registers purchased goods into the basic unit C3 (step 073). When the goods registration is finished (step 074), the basic unit C3 carries out the calculation processing (step 075), and the basic unit C3 sends the purchase information from the network access unit C1 to the agent service system Y (step 076).

3-2. Scenario II

When the user recalls that there is a need to buy milk on the way back to the home while working at the office, the user can call up the own agent on the PC in the office and add milk to the purchase memo, such that the user can view the purchase memo at the portable telephone terminal D1 or the shop's information terminal B while going back to the home or the user can receive the notification to the portable telephone terminal D1 when the user comes near a convenience store or a supermarket, so that it is possible to prevent the user from forgetting to buy milk. Note that the functions of the agent may be utilized through a web page by constantly accessing the agent service system Y via the network N such as the Internet, or the electronic goods information such as the purchase memo may be updated by activating the dedicated user application on a client terminal such as PC and carrying out communications between this application and the agent service system Y.

Also, when the user working at the office is a husband and a wife at the home notices that they are running out of the soy source, the wife can add the soy source to the purchase memo in the electronic goods information shared with the husband through the agent of the husband from the PC at the home, such that the husband will also purchase the soy source on the way back to the home.

3-2-1. Pattern 1: Notification Using the Portable Telephone

Even if the user who should purchase some goods on the way back to the home as described above happens to forget about it at a time of going back to the home, the portable telephone of the user will be rung suddenly when the user comes near the convenience store in vicinity of the home, and the user will be reminded of the need to purchase some goods from the own agent either by a text message on the screen or by a synthesized speech message, and a corresponding list of goods to be purchased is displayed on the screen at the convenience store so that it is possible to prevent the user from forgetting to purchase these goods effectively.

3-2-2. Pattern 2: Notification Using the Shop's Information Terminal

When the above user inserts the own IC card into the shop's information terminal B provided inside the convenience store that the user stopped by on the way back to the home, the user can view the purchase memo indicating “milk” entered by the user and “soy source” added by the wife at the home. At the same time, a map of the layout inside the shop is displayed on the screen and the locations of these goods in the shop are indicated. In addition, the new product information on the confectionery that the user often buys is displayed on the terminal. Consequently, it becomes possible for the user to smoothly purchase goods to be purchased as well as goods of the interest.

3-3. Scenario III

The user can register anniversaries into a schedule note which is an application software on the PC used at the office or the home, and these anniversaries can include the wife's birthday. The user can then send data of such an application to the agent service system Y, such that the user can be notified that the wife's birthday is approaching by the own agent about one month before the wife's birthday, for example, along with the wife's preference and the proposal for the birthday gift based on the user's budget. In this way, the user can avoid deteriorating the human relationship by forgetting the important anniversary. For example, the user can access a WWW page of some jewelry shop upon consulting the information from the agent and narrow down some candidate jewels by viewing the catalog, and then purchase the jewel for a gift by visiting the actual jewelry shop.

Also, the user can produce a birthday card secretly on the PC at the home, and decide to print it out using the electronic printing service of the convenience store as there is no printer at the home. To this end, the user can give the electronic data indicating text and design of the birthday card to the own agent. In this way, the user can be notified of the existence of data that have not been printed yet from the agent on the PC when the birthday approaches, such that the user can go to the convenience store, call up the own agent by inserting the IC card into the shop's information terminal B, and print the birthday card by utilizing the data of the birthday card given to the agent via the network, so as to avoid forgetting the printing of the birthday card. In this way, in this scenario, the user can prepare the birthday gift and the birthday card without forgetting the wife's birthday, so that that the user can handle the wife's birthday with sufficient preparation and thereby maintain the good relationship with the wife.

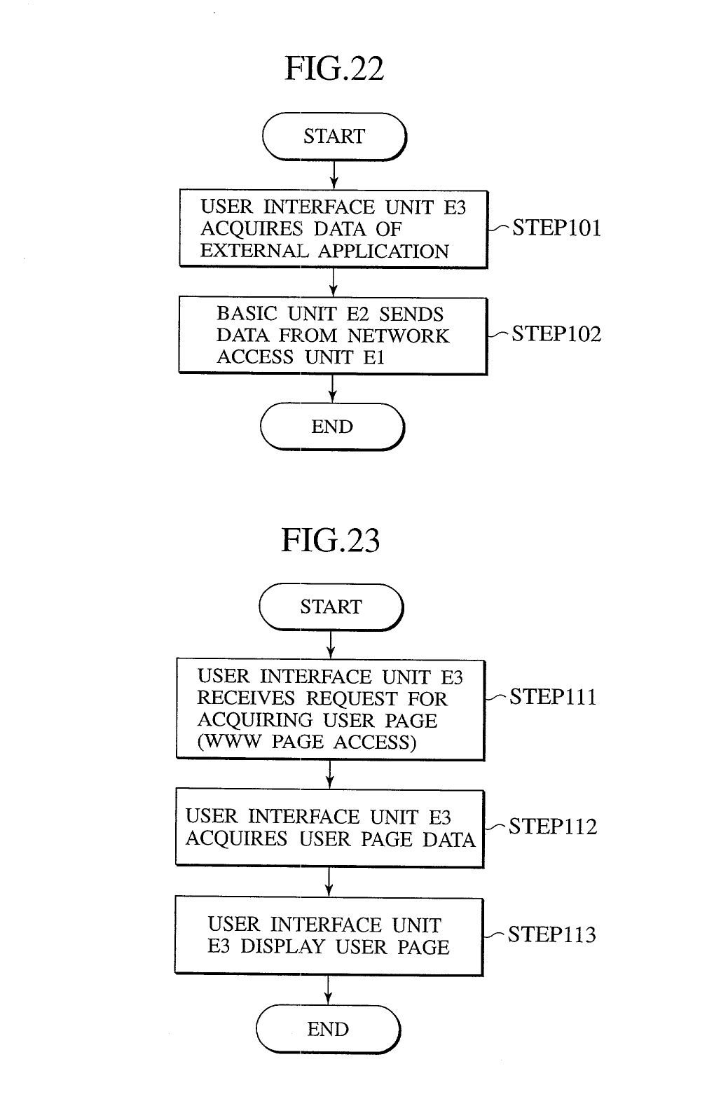

Here, in the case of sending data of the external application such as the scheduling application unit E4, such as the anniversaries setting, for example, from the office user system E such as PC to the agent service system Y, the office user system E operates according to the procedure shown in FIG. 22, for example. Namely, when the user interface unit E3 acquires the data of the external application (step 101), the basic unit E2 sends the data from the network access unit E1 to the agent service system Y (step 102).

It is preferable to confirm the personal information such as the anniversaries described above, using a dedicated user page in the WWW page format managed by the agent. In this case, the office user system E operates according to the procedure shown in FIG. 23, for example. Namely, when the user interface unit E3 receives the request for acquiring the user page (step 111), the user interface unit E3 acquires the corresponding user page data (step 112), and displays that user page (step 113).

3-4. Another Exemplary Case of Utilizing the Office User System

It is also possible to enter the information regarding which goods are actually purchased by each user into the various external applications utilized at the client system such as the office user system E via the network N from the POS register C of the shop, and process that information.

By entering the information on the purchase log based on the actual purchases from the POS register C of the shop into the various application software for managing the purchase records such as the housekeeping account book or cashbook and utilizing it in this way, it becomes possible to reduce the input task for producing data of the housekeeping account book or the like. More specifically, a transaction ID for identifying each transaction can be printed on a receipt issued from the POS register C of the shop, and the user can enter the transaction ID into the housekeeping account book software on the PC at the home after returning to the home and acquire data via the network. In this way, it becomes possible to carry out the authentication by matching the transaction IDs so that the user authentication at a time of the purchase becomes unnecessary.

4. Effects

As described, in this embodiment, by the operations of the user information database Y2 and the user information management unit Y1 of the agent service system Y, the user can store the purchase memo information produced in a text file or other format into a network server and view it any time anywhere including inside the shop, using a desired information communication terminal such as a portable information terminal. For this reason, there is no need to store the purchase memo information or the like in a dedicated PDA (Personal Digital Assistant) and carry that PDA around, and the purchase memo information is freely accessible from a plurality of terminals including PDA, portable telephone, PC, etc., so that the shopping can be made more easily and readily and therefore the purchases can be promoted more effectively.

Also, in this embodiment, by the operations of the user state judgement unit Y3 and the user information providing unit Y4 of the agent service system Y, the purchase memo information or the like can be notified to an information communication terminal that is currently used by the user, so that it is possible to reduce occasions of forgetting to buy something and therefore the purchases can be promoted more effectively.

Also, in this embodiment, by the operations of the user state judgement unit Y3 and the user information providing unit Y4 of the agent service system Y, the information to be provided to the user can be collected by searching and narrowing down the electronic goods information on the network, the other goods purchase information, etc., according to the state data indicating the state of the user, so that it becomes possible to promote purchases more effectively by providing appropriate information.

Also, in this embodiment, the management of the electronic goods information for each user is entrusted to the dedicated agent of each user, so that the user can be identified more easily and accurately. Namely, by utilizing the fact that the accessing user knows the “agent name” of the own dedicated agent as an identification information, it is possible to complement the conventional identification using the user ID+password or the identification using information maintained in a physical device such as the an ID of an IC card or a portable telephone terminal, so that it becomes possible realize the more accurate user authentication and the improved security.

Also, in this embodiment, by the operations of the user information providing unit Y4 of the agent service system Y and the goods information system A, it is possible to provide the user with the information regarding goods scheduled to be purchased or goods desired to be purchased, which can include the “purchase memo” actively produced by the user and the “goods checking information” such as goods advertisement, as well as the out-of-stock information obtained from the information technology based home electronic appliance or the new product information matching with the preference information extracted from the purchase log, so that it becomes possible to promote purchases more effectively and accurately.

Here, the shop that produced the advertisement or the new product information to be provided to the user in this way can also enjoy the benefit of the effective advertisement of goods on sale at the shop, and the agent service system may charge the advertisement fee for this advertisement service from the shop.

Also, in this embodiment, it is possible to obtain the information on the purchase log such as the sales records for each user from the POS register of the shop, so that it becomes possible to produce the purchase log of each user more easily and accurately, and it becomes possible to reduce the user's task for inputting data of the purchase memo or the like.

Also, in this embodiment, by sharing the electronic goods information such as the purchase memo information among a plurality of users, it is possible to avoid the failure to buy something or the purchase in duplication among the family members or the office members based on a guess that the other member would buy or the other member would not buy, so that it becomes possible to promote purchases more effectively and accurately.

Thus, according to this embodiment, it is possible to realize a scheme for promoting purchases more effectively by utilizing characteristics of a computer network such as its ability to cover a wide area and support bidirectional communications, so that it is possible to contribute to the economical effect of spreading the electronic commerce.

As described, according to one aspect of the present invention, the purchase promotion system can be provided with: a unit for producing electronic goods information for goods scheduled to be purchased or goods desired to be purchased and storing it on the network such that it can be viewed by a device accessible to the network; a unit for recognizing a device currently used by the user and notifying the stored electronic goods information for goods scheduled to be purchased or goods desired to be purchased to that device; and a unit for interpreting data indicating the state of the user by utilizing another data for interpretation, collecting information according to the user state and presenting the information according to the user's preference.

The purchase promotion system may also be provided with: a unit for producing electronic goods information for a unit for identifying the user by entrusting the storing and the providing of the electronic goods information for goods scheduled to be purchased or goods desired to be purchased to the agent dedicated to the user; and a unit for utilizing the purchase memo actively produced by the user and the goods checking information such as goods advertisement as well as the out-of-stock goods information based on the stock management of a refrigerator, out-of-stock goods information based on the cooking recipe executed by a microwave oven, and a new product information based on the preference information extracted from the past purchase log, as information on goods scheduled to be purchased or goods desired to be purchased.

The purchase promotion system may also be provided with: a unit for producing the user's purchase log by extracting a list of goods actually purchased, i.e., the purchase records, from the POS system; a unit for reducing the input for producing housekeeping account book by extracting the purchase records from the POS system via the network as the purchase log, and utilizing them as input for the purchase record management software such as that of the housekeeping account book and the cashbook; and a unit for sharing the electronic goods information for goods scheduled to be purchased or goods desired to be purchased among a plurality of users.

In this purchase promotion system, it is possible to store the information regarding the purchases of the individual user such as the information on goods scheduled to be purchased, electronically in an accessible format on the network, interpret the user state from various information such as the current location, and notify the goods information intended for the user that is obtained according to the information regarding the purchases of the user, to the user at appropriate timing without requiring the information access operation by the user.

Also, in another aspect of the present invention, the user can store the purchase memo information produced in a text file or other format into a network server and view it any time anywhere including inside the shop, using a desired information communication terminal such as a portable information terminal. For this reason, there is no need to store the purchase memo information or the like in a dedicated PDA and carry that PDA around, and the purchase memo information is freely accessible from a plurality of terminals including PDA, portable telephone, PC, etc., so that the shopping can be made more easily and readily and therefore the purchases can be promoted more effectively. Here, the goods advertisement or the goods checking information such as information on goods that the user wishes to check in person before purchasing may also be included in the electronic goods information, or may be provided to the user separately from the electronic goods information.

Also, in another aspect of the present invention, the purchase memo information or the like can be notified to an information communication terminal that is currently used by the user, so that it is possible to reduce occasions of forgetting to buy something and therefore the purchases can be promoted more effectively.

As a concrete example, it is possible to notify the information on goods that can be purchased at a shop to the portable telephone when the user passes in front of that shop, or even if the user does not have the portable telephone, it is possible to display the information when the user makes log-in to the monitor TV or the multimedia terminal provided in the shop, for example. Also, if the user is moving with the portable telephone, it is possible to sends an e-mail to the portable telephone, or if the user is using the PC at the office, it is possible to popup (automatically display) a dialog (a dialog box or a dialog window which is a window for displaying information) on the screen.

Here, the way of recognizing the device used by the user is not limited to any specific way, but this can be done by notifying the user ID from the information communication terminal in-to which the IC card carried around by the user is inserted. Also, the way of notifying the electronic goods information to the information communication terminal is not limited to any specific way such as the e-mail or the dialog pop-up mentioned above.

Also, in another aspect of the present invention, the location information such as latitude and longitude of the portable information communication terminal carried around by the user, the current time, etc., are entered as state data indicating the real time state of the user. On the other hand, the located area information indicating facilities in vicinity of each set of latitude and longitude, the schedule information registered by the user in advance, the utilized terminal information indicating a type of the information communication terminal utilized by the user, the activity log indicating the user's working time zone, etc., are provided as interpretation data for interpreting the state data.

Then, for example, the information on latitude and longitude is acquired from the location information service of the portable telephone, and the user state of “being located in front of a convenience store” is obtained by interpreting the located area information corresponding to the acquired latitude and longitude or the user state of “on the way back to the home” is obtained by interpreting the current time according to the schedule information. Then, the information to be provided to the user can be collected by searching and narrowing down the electronic goods information on the network, the other goods purchase information, etc., according to the state data indicating the state of the user, so that it becomes possible to promote purchases more effectively by providing appropriate information.

In providing the collected information to the user, the setting of “presenting all” or “presenting most recommended”, for example, is made in advance according to the user's preference using the automatic analysis based on the past selection or reaction made by the user, and the information is provided according to this setting.

Also, in another aspect of the present invention, the management of the electronic goods information for each user is entrusted to the dedicated agent of each user, so that the user can be identified more easily and accurately. Namely, by utilizing the fact that the accessing user knows the “agent name” of the own dedicated agent as an identification information, it is possible to complement the conventional identification using the user ID+password or the identification using information maintained in a physical device such as the an ID of an IC card or a portable telephone terminal, so that it becomes possible realize the more accurate user authentication and the improved security.

Also, in another aspect of the present invention, it is possible to provide the user with the information regarding goods scheduled to be purchased or goods desired to be purchased, which can include the “purchase memo” actively produced by the user and the “goods checking information” such as goods advertisement, as well as the out-of-stock information obtained from the information technology based home electronic appliance or the new product information matching with the preference information extracted from the purchase log, so that it becomes possible to promote purchases more effectively and accurately.

As a concrete example, the stock management is carried out by the bar code reading at times of entering and taking out goods from a refrigerator, so as to comprehend states such as beers that should always be present in the refrigerator are out-of-stock, cheese has its recommended period of consumption expired, etc., and add them to the electronic goods information as goods desired to be purchased. Similarly, states such as the recipe using ten eggs has been executed by the microwave oven can be comprehended so as to comprehend the out-of-stock information in cooperation with the stock management of the refrigerator and eggs can be added to the electronic goods information as goods desired to be purchased. Similarly, the user's preference of potato chips can be extracted from the purchase log indicating many purchases of potato chips, and a new potato chips product can be added to the electronic goods information as goods desired to be purchased. Here, the known technique such as the data mining can be used for the extraction of the preference information.

Also, in another aspect of the present invention, it is possible to obtain the information on the purchase log such as the sales records for each user from the POS system of the shop, so that it becomes possible to produce the purchase log of each user more easily and accurately, it becomes possible to delete the already purchased goods from the electronic goods information such as the purchase memo, and it becomes possible to reduce the user's task for inputting data of the purchase memo or the like.

Here, the authentication necessary at a time of providing information on transactions or the like from the POS system to the purchase promotion system can be done by giving the transaction ID to the agent or by giving the agent ID to the POS system, for example. Also, independently from this authentication, the information on the purchase log may be extracted from the POS system by the agent side, or written from the POS system side.

Also, in another aspect of the present invention, by sharing the electronic goods information such as the purchase memo information among a plurality of users, it is possible to avoid the failure to buy something or the purchase in duplication among the family members or the office members based on a guess that the other member would buy or the other member would not buy, so that it becomes possible to promote purchases more effectively and accurately.

For example, in the case of sharing the purchase memo concerning milk that is scheduled to be purchased in the family in which both husband and wife go to works, at a time of checking the purchase memo at the convenience store on the way back to the home, the purchase memo still contains milk if the husband is coming back earlier than the wife but milk is already deleted from the purchase memo if the wife already purchased it so that it is possible for the husband to easily and accurately comprehend whether milk should be purchased or not without confirming the need by calling the wife using a telephone.

Also, in another aspect of the present invention, by entering the information on the purchase log based on the actual purchases from the POS system of the shop into the various application software for managing the purchase records such as the housekeeping account book or cashbook and utilizing it, it becomes possible to reduce the input task for producing data of the housekeeping account book or the like.

As a concrete example, a transaction ID for identifying each transaction can be printed on a receipt issued from the POS system of the shop, and the user can enter the transaction ID into the housekeeping account book software on the PC at the home after returning to the home and acquire data via the network. In this way, it becomes possible to carry out the authentication by matching the transaction IDs so that the user authentication at a time of the purchase becomes unnecessary.

It is to be noted that, in the purchase promotion system of the above described embodiment, the goods information system A, the shop's information terminal B, the POS register C, the Internet refrigerator F, and the office user system E are not indispensable elements and any of them can be omitted if desired.

It is also to be noted that the above described embodiment according to the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art.

In particular, the agent service system of the above described embodiment can be conveniently implemented in a form of a software package.

Such a software package can be a computer program product which employs a storage medium including stored computer code which is used to program a computer to perform the disclosed function and process of the present invention. The storage medium may include, but is not limited to, any type of conventional floppy disks, optical disks, CD-ROMs, magneto-optical disks, ROMs, RAMs, EPROMs, EEPROMs, magnetic or optical cards, or any other suitable media for storing electronic instructions.

It is also to be noted that, besides those already mentioned above, many modifications and variations of the above embodiment may be made without departing from the novel and advantageous features of the present invention. Accordingly, all such modifications and variations are intended to be included within the scope of the appended claims.

What is claimed is:

1. A purchase promotion server system, comprising:
a user information database unit configured to store electronic goods/services information indicating goods/services scheduled to be purchased or goods/services desired to be purchased, for each user;
a user state judgement unit configured to judge a user state of a user regarding whether the user is fit to purchasing of goods/services, according to state data including a location information of the user; and
a user notification unit configured to send a message urging/reminding the user to purchase the goods/services scheduled to be purchased or the goods/services desired to be purchased indicated by the electronic goods/services information stored by the user information database unit, to the user via a network according to the user state of the user judged by the user state judgement unit.

2. The system of claim 1, wherein the user state judgement unit judges the user state by using a located area information describing an area in which the user is currently located according to a current location of the user indicated by the location information.

3. The system of claim 2, wherein the user state judgement unit uses the located area information describes facilities existing in the area in which the user is currently located.

4. The system of claim 3, wherein the user state judgement unit judges that the user is fit to purchasing of the goods/services scheduled to be purchased or the goods/services desired to be purchased, when the user is located in an area with a facility at which at least one of the goods/services schedules to be purchased or the goods/services desired to be purchased can be purchased.

5. The system of claim 1, wherein the user state judgement unit judges the user state according to the state data that also includes a time information indicating a current time.

6. The system of claim 5, wherein the user state judgement unit judges the user state by using a schedule information describing scheduled activities of the user according to the current time indicated by the time information.

7. The system of claim 6, wherein the user state judgement unit judges that the user is fit to purchasing of goods/services when the current time is not in a working time zone of the user according to the schedule information.

8. The system of claim 1, wherein the user notification unit recognizes an information communication terminal currently used by the user, and sends the message in a format suitable to the information communication terminal.

9. The system of claim 1, wherein the user notification unit sends the message in a form of an e-mail destined to a portable information communication terminal carried around by the user.

10. The system of claim 1, further comprising:
a user information providing unit configured to provide contents including the electronic goods/services information, in a form accessible by the user via the network.

11. The system of claim 10, further comprising:
a contents production unit configured to produce the contents to be provided by the user information providing unit, according to the user state of the user judged by the user state judgement unit.

12. The system of claim 11, wherein the contents production unit produces the contents by collecting related information relevant to a current location of the user indicated by the location information.

13. The system of claim 12, wherein the contents production unit produces the contents including the related information which is an advertisement/recommendation of a shop existing in an area in which the user is currently located.

14. The system of claim 10, wherein the user information providing unit provides the contents that also include at least one of:
(1) an out-of-stock goods information based on a stock management of a refrigerator of the user;
(2) an out-of-stock goods information based on a cooking recipe executed by a microwave oven of the user; and
(3) a new product information based on a preference information of the user extracted from a past purchase log.

15. The system of claim 10, wherein the user notification unit sends the message that is linked to the contents provided by the user information providing unit.

16. The system of claim 1, wherein the user notification unit sends the message that also contains the electronic goods/services information.

17. The system of claim 1, wherein operations of the user information database unit, the user state judgement unit, and the user notification unit are provided in a form of an agent service to be provided to each user individually.

18. The system of claim 1, further comprising:
a user information management unit configured to manage the electronic goods/services information and a purchase log of the user by obtaining a purchase record information indicating goods/services actually purchased by the user from a POS system of each shop used by the user and updating at least one of the electronic goods/services information and the purchase log of the user.

19. The system of claim 18, wherein the user information management unit manages the electronic goods/services information that is shared by a plurality of users.

20. A purchase promotion method, comprising:
storing electronic goods/services information indicating goods/services scheduled to be purchased or goods/services desired to be purchased, for each user;
judging a user state of a user regarding whether the user is fit to purchasing of goods/services, according to state data including a location information of the user; and
sending a message urging/reminding the user to purchase the goods/services scheduled to be purchased or the goods/services desired to be purchased indicated by the electronic goods/services information stored by the storing step, to the user via a network according to the user state of the user judged by the judging step.

21. The method of claim 20, wherein the judging step judges the user state by using a located area information describing an area in which the user is currently located according to a current location of the user indicated by the location information.

22. The method of claim 21, wherein the judging step uses the located area information that describes facilities existing in the area in which the user is currently located.

23. The method of claim 22, wherein the judging step judges that the user is fit to purchasing of the goods/services scheduled to be purchased or the goods/services desired to be purchased, when the user is located in an area with a facility at which at least one of the goods/services schedules to be purchased or the goods/services desired to be purchased can be purchased.

24. The method of claim 20, wherein the judging step judges the user state according to the state data that also includes a time information indicating a current time.

25. The method of claim 24, wherein the judging step judges the user state by using a schedule information describing scheduled activities of the user according to the current time indicated by the time information.

26. The method of claim 25, wherein the judging step judges that the user is fit to purchasing of goods/services when the current time is not in a working time zone of the user according to the schedule information.

27. The method of claim 20, wherein the sending step recognizes an information communication terminal currently used by the user, and sends the message in a format suitable to the information communication terminal.

28. The method of claim 20, wherein the sending step sends the message in a form of an e-mail destined to a portable information communication terminal carried around by the user.

29. The method of claim 20, further comprising:
providing contents including the electronic goods/services information, in a form accessible by the user via the network.

30. The method of claim 29, further comprising:
producing the contents to be provided by the providing step, according to the user state of the user judged by the judging step.

31. The method of claim 30, wherein the producing step produces the contents by collecting related information relevant to a current location of the user indicated by the location information.

32. The method of claim 31, wherein the producing step produces the contents including the related information which is an advertisement/recommendation of a shop existing in an area in which the user is currently located.

33. The method of claim 29, wherein the providing step provides the contents that also include at least one of:
(1) an out-of-stock goods information based on a stock management of a refrigerator of the user;
(2) an out-of-stock goods information based on a cooking recipe executed by a microwave oven of the user; and
(3) a new product information based on a preference information of the user extracted from a past purchase log.

34. The method of claim 29, wherein the sending step sends the message that is linked to the contents provided by the providing step.

35. The method of claim 20, wherein the sending step sends the message that also contains the electronic goods/services information.

36. The method of claim 20, wherein operations of the storing step, the judging step, and the sending step are provided in a form of an agent service to be provided to each user individually.

37. The method of claim 20, further comprising:
managing the electronic goods/services information and a purchase log of the user by obtaining a purchase record information indicating goods/services actually purchased by the user from a POS system of each shop used by the user and updating at least one of the electronic goods/services information and the purchase log of the user.

38. The method of claim 37, wherein the managing step manages the electronic goods/services information that is shared by a plurality of users.

39. A computer usable medium having computer readable program codes embodied therein for causing a computer to function as a purchase promotion server system, the computer readable program codes include:
a first computer readable program code for causing said computer to store electronic goods/services information indicating goods/services scheduled to be purchased or goods/services desired to be purchased, for each user;
a second computer readable program code for causing said computer to judge a user state of a user regarding whether the user is fit to purchasing of goods/services, according to state data including a location information of the user; and
a third computer readable program code for causing said computer to send a message urging/reminding the user to purchase the goods/services scheduled to be purchased or the goods/services desired to be purchased indicated by the electronic goods/services information stored by the user information database unit, to the user via a network according to the user state of the user judged by the user state judgement unit.

40. A method for providing advertisement service, comprising:
judging a user state of a user regarding whether the user is fit to purchasing of goods/services, according to state data including a location information of the user;
producing contents according to the user state of the user judged by the judging step, by collecting related information relevant to a current location of the user indicated by the location information, the related information being an advertisement/recommendation of a shop existing in an area in which the user is currently located; and
providing the contents produced by the producing step, in a form accessible by the user via the network.
